(19) United States
(12) Patent Application Publication
(10) Pub. No.: US 2010/0229710 A1
(43) Pub. Date: Sep. 16, 2010

(54) EFFECTS DEVICE CONTROLLER

(76) Inventor: Jan Schoewer, Bochum (DE)

Correspondence Address: COLLARD & ROE, P.C., 1077 NORTHERN BOULEVARD, ROSLYN, NY, 11576, US

(21) Appl. No.: 12/734,490

(22) PCT Filed: Nov. 5, 2008
(86) PCT No.: PCT/EP2008/009302

§ 371 Date: May 13, 2010

(30) Foreign Application Priority Data
Nov. 5, 2007 (DE) 10 2007 052 991.2

(51) Int. Cl. G10H 1/02

(52) U.S. Cl. 84/701

(57) ABSTRACT

The invention relates to an apparatus for storing and generating sound effects with the help of analog devices (5, 6) when playing a musical instrument. The apparatus comprises one or more positioning motors (4) which can be connected to potentiometers of the analog devices (5, 6) by means of shafts (7). The apparatus further comprises means for storing and retrieving the settings of the positioning motors (4), a specific setting of the positioning motors (4) being used for generating a specific sound effect. By connecting the apparatus to many different types of analog effects devices (5) and tube amplifiers (6), the apparatus according to the invention allows specific sound effects to be preprogrammed and stored which the musician can easily retrieve as required, without having to make adjustments to the analog devices (5, 6).

The invention relates to an apparatus for storing and generating sound effects with the help of analog devices, when playing a musical instrument.

When playing musical instruments, it is usual in pop and rock music to generate specific sound effects with the help of so-called effects devices, whereby the audio signal generated by the musical instrument is modified. The production of sound effects has particular significance when playing electromechanical and electronic musical instruments, for example an electric guitar or an electric bass.

In this connection, for the musician, being able to rapidly access a specific sound effect regularly presents a problem. This is particularly true for the live situation. It is true that various guitar amplifiers, for example, as well as effects devices and so-called multi-effects devices are available on the market, which offer the possibility of internal effects and are programmable, specifically in the sense that a plurality of pre-programmed effects can be stored and retrieved. However, these are digital devices. Many musicians continue to prefer analog devices, for example tube amplifiers, since the sound generated by the analog devices is generally viewed as being better, particularly warmer and more impressive. Therefore demanding musicians reject the use of digital devices, in many cases.

However, these analog devices in turn are generally not programmable, in other words, in order to adjust a specific sound effect, one has to set the potentiometers (pots) in a specific manner. Since no time is available for making these adjustments during a musician's performance, until now a corresponding effects device, pre-set to the desired sound effect, had to be on hand for every sound effect that one wanted to have available for retrieval. For example, if one wanted to generate 13 different sound effects, for example, with the help of a specific effects device, one required 13 corresponding effects devices of this type, pre-set to the various sound effects. The effort (and expense) is therefore significant.

Proceeding from the state of the art as described, the task therefore arises of making available an apparatus that makes it possible to store sound effects when playing a musical instrument, and to generate them with the help of analog devices, without having to keep a plurality of similar effects devices on hand, whereby calling up a specific sound effect takes place in sufficiently fast and simple manner so that it can occur during a performance.

This task is accomplished, according to the invention, by means of an apparatus for storing and generating sound effects with the help of analog devices when playing a musical instrument, whereby the apparatus has one or more positioning motors that can be connected with potentiometers of the analog devices by way of shafts, whereby the apparatus has means for storing and retrieving the settings of the positioning motors, and whereby a specific setting of the positioning motors serves for generating a specific sound effect.

According to the invention, an apparatus is thus made available, which has positioning motors, whose setting corresponds with the corresponding setting of a potentiometer of the analog device. In this connection, the force between the potentiometer and the positioning motor is transferred by way of a preferably flexible shaft. Different settings of the positioning motors can be stored with the help of the apparatus, and in turn, the generation of a specific sound effect is linked with this. As soon as a specific sound effect is therefore retrieved at the apparatus, the positioning motor goes into motion and adjusts the potentiometer of the corresponding analog device by way of the intermediate shaft.

The analog devices can be conventional effects devices and tube amplifiers, i.e. no losses with regard to the sound produced have to be feared, despite the programmability of a plurality of sound effects. The invention thus combines the high sound quality of analog devices with the programmability and simple retrievability of sound effects that could only be offered by digital devices until now.

Since the musician can very easily retrieve a specific sound effect by using the apparatus according to the invention, he no longer has to adjust the corresponding analog device himself, something that would hardly be possible during a performance, and instead, the adjustment is made by way of the positioning motors of the apparatus. Accordingly, it is also not necessary to provide a plurality of similar effects devices in order to pre-set different sound effects. Normally, a specific effects device is required only once when using the apparatus according to the invention, since the various desired settings are stored by the apparatus and can be retrieved directly. The number of possible pre-settings is fundamentally as desired, and can amount to approximately 100, for example.

In total, an apparatus that can be used very compatibly is thus proposed by the invention, which apparatus can be connected with the most varied types of analog devices, and therefore can be used very flexibly, and, at the same time, combines the high sound quality of analog devices with functionalities of digital devices. In this way, not only is the advantage achieved that the number of similar analog devices can be reduced, and thus enormous costs can be saved, but also, the apparatus can be used very individually and variably, together with the most varied analog devices, and this is very much in the musician's interests.

It is practical if the positioning motors of the apparatus are controlled by means of a control unit. This can be, for example, a control circuit board as they are present in digital amplifiers. The positioning motors, which are put into motion by the control unit, are connected with the control unit. The control unit can be surrounded by a metal housing, for example an aluminum housing, in order to avoid pickup.

Typically, the apparatus furthermore has a controller unit for storing and retrieving the settings of the positioning motors, whereby the controller unit is connected with the control unit.

The controller unit can also be a circuit board as it is used in digital amplifiers. The musician calls up a specific positioning motor setting on the controller unit when he wants to set a specific sound effect, and this setting is passed on to the control unit, which in turn puts the positioning motor into motion and adjusts the potentiometer by way of the shaft between positioning motor and potentiometer. The controller unit furthermore requires a memory for storing the various positioning motor settings, as well as operating elements for the user.

The analog devices are, in particular, typical musical effects devices as they are frequently used by guitarists or also bassists. Furthermore, analog tube amplifiers as well as other devices having a potentiometer can also be connected with the apparatus, for example light effects devices. The analog devices are typically external. Accordingly, they can be commercially available analog devices that the musician already has, in any case, and that merely have to be connected with the apparatus according to the invention. Fundamentally, however, it is also possible to integrate the analog devices into the apparatus itself, whereby if necessary, a fixed connection between positioning motors and potentiometers can also be provided.

The analog effects devices are typically such effects devices as they are frequently used by musicians and that change an audio signal in different ways. For example, distorting effects devices, level-oriented effects devices, effects devices that cause changes in the frequency range, time-oriented effects devices, or delay-time-oriented effects devices are known. In particular, the effects device can be selected from the group consisting of: distorter, compressor, limiter, noise gate, chopper, rectifier, enhancer, exciter, pitch shifter, harmonizer, ring modulator, talk box, vibrato, Leslie cabinet, auto-tune, intonator, equalizer, wah-wah, time shifter, tremolo, reverberator, delay device, echo device, chorus, flanger, phaser, octaver. In most cases, at least some of the effects devices are floor effects devices as they are frequently used by guitarists, since they can be operated with the foot.

As has already been mentioned, the apparatus has particular significance for the use of electric guitars or electric basses. Fundamentally, however, the apparatus according to the invention can also be used for other electrical and non-electrical musical instruments, for example acoustic guitars, wind instruments such as trumpet, trombone, saxophones (for example in jazz), Hammond organs, etc.

It is practical if the shafts that are disposed between the potentiometers and the positioning motors are configured to be flexible, in order to simplify connecting the external analog devices. As a rule, connections between the other components of the apparatus exist by way of suitable cables; for example, the positioning motors can be connected with the control unit by way of five-pole XLR cables. Corresponding cable connections also exist between control unit and controller unit, whereby any desired suitable cables can be used. Of course, however, control unit, controller unit, and positioning motors do not have to be spatially separated from one another, so that under some circumstances, it is not necessary to provide cables between the various sub-units. Preferably, the entire apparatus is accommodated in a housing, but this does not necessarily have to be the case.

Aside from the controller unit that has already been mentioned, the apparatus can also have a MIDI controller unit that transmits MIDI signals and is connected with the control unit by way of MIDI cables. Such MIDI devices (for example so-called MIDI controllers) are easily available commercially. In this manner, analog devices that are not MIDI-capable can be controlled indirectly, by way of MIDI, with the help of the apparatus according to the invention.

It is practical if the apparatus also has a visual display apparatus for displaying the selected sound effect, in each instance. Such a display apparatus can particularly be integrated into the controller unit, for example as an LED display. The display apparatus can display various program spaces (1, 2, 3, . . . ) and/or also specific settings (for example clean, crunch, drive, etc.).

The apparatus according to the invention is also excellently suited for integration into a so-called “pedal board.” In a pedal board, multiple musical effects devices are disposed next to one another on a support, so that they can be activated by the musician, using his foot. The apparatus according to the invention can also be disposed on the support of the pedal board, whereby it is practical if the control unit and the controller unit are integrated into a compact device. It is practical if the positioning motors are disposed in the vicinity of the effects devices, in each instance, on the support, so that the flexible shafts can be kept short. The connection of the positioning motors with the control unit of the apparatus takes place in simple manner, by way of cables. The operation of the apparatus (for example for selecting specific programs) can also take place using the foot, by way of corresponding foot switches integrated into the apparatus or connected with it.

The invention will be explained in greater detail using the attached figures. The drawing shows:

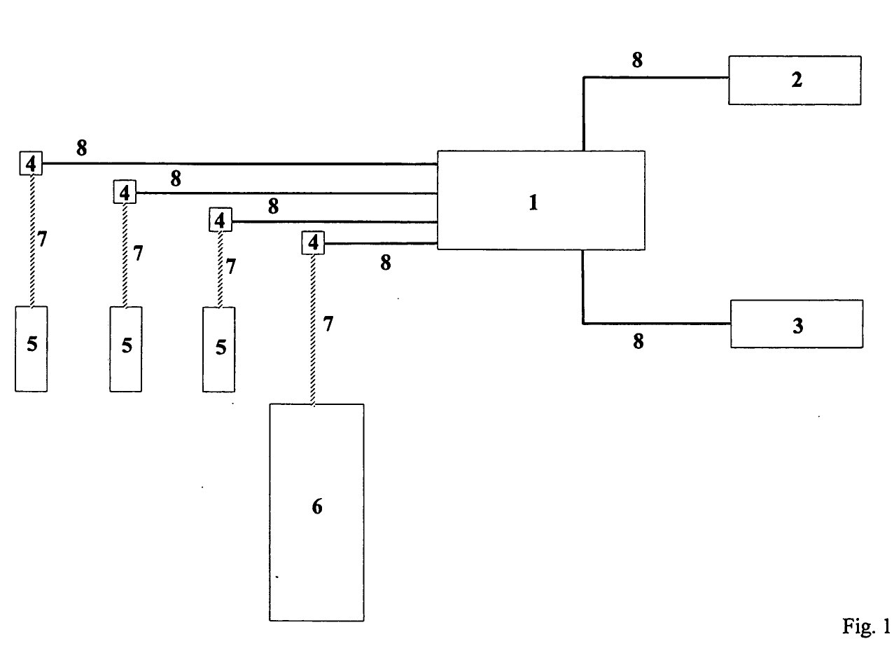

FIG. 1 the structure of the apparatus according to the invention, in a schematic representation.

According to the representation in FIG. 1, a control unit 1 is connected with a controller unit 2 as well as an additional MIDI controller unit 3 by way of cables 8. On the other side, the control unit 1 is connected, also by way of cables 8, with corresponding positioning motors 4 that can adjust the potentiometers of the effects devices 5 and of the tube amplifier 6 by way of flexible shafts 7. As soon as a specific sound effect is called up at the controller unit 2, the controller unit 2 passes the corresponding information on to the control unit 1, which causes a movement of the corresponding positioning motor 4. The movement of the positioning motor 4, in turn, is directly passed on to the potentiometer of the corresponding effects device 5 or of the tube amplifier 6, respectively, by way of the shaft 7, in other words the setting of the positioning motor 4 directly correlates with the characterization of the potentiometer on the corresponding analog device 5, 6. Even though all the components of the apparatus are represented separately in FIG. 1, it is of course possible to provide all the components in a housing, so that as a rule, only the effects devices 5 or the tube amplifier 6, respectively, which were already present beforehand, have to be connected to the apparatus.

1. Apparatus for storing and generating sound effects with the help of analog devices (5, 6) when playing a musical instrument, wherein the apparatus has one or more positioning motors (4) that can be connected with potentiometers of the analog devices (5, 6) by way of shafts (7), whereby the apparatus has means for storing and retrieving the settings of the positioning motors (4), and whereby a specific setting of the positioning motors (4) serves to generate a specific sound effect.

2. Apparatus according to claim 1, wherein the positioning motors (4) are controlled by a control unit (1).

3. Apparatus according to claim 2, comprising a controller unit (2) for storing and retrieving the settings of the positioning motors (4), whereby the controller unit (2) is connected with the control unit (1).

4. Apparatus according to claim 2, wherein the control unit (1) and the controller unit (2) are integrated into a compact device, whereby the positioning motors (4) are either also integrated into the device or connected with it by way of cable connections.

5. Apparatus according to claim 1, wherein the analog devices are musical effects devices (5), tube amplifiers (6) and/or light effects devices.

6. Apparatus according to claim 5, wherein the effects devices (5) are selected from the group consisting of: distorter, compressor, limiter, noise gate, chopper, rectifier, enhancer, exciter, pitch shifter, harmonizer, ring modulator, talk box, vibrato, Leslie cabinet, auto-tune, intonator, equalizer, wah-wah, time shifter, tremolo, reverberator, delay device, echo device, chorus, flanger, phaser, octaver.

7. Apparatus according to claim 5, wherein at least some of the effects devices (5) are floor effects devices.

8. Apparatus according to claim 1, wherein the musical instrument is an electric guitar or an electric bass.

9. Apparatus according to claim 1, wherein the shafts (7) are flexible.

10. Apparatus according to claim 1, further comprising a separate MIDI controller unit (3).

11. Apparatus according to claim 1, further comprising a visual display apparatus for displaying the set sound effect.
